(19) United States
(12) Patent Application Publication
(10) Pub. No.: US 2025/0081086 A1
(43) Pub. Date: Mar. 6, 2025

(54) INFORMATION TRANSMISSION METHOD AND APPARATUS, AND COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(21) Appl. No.: 18/728,616

(22) PCT Filed: Jan. 14, 2022
(86) PCT No.: PCT/CN2022/072180

§ 371 Date: Jul. 12, 2024

(51) Int. Cl. H04W 48/06

(52) U.S. Cl. CPC H04W 48/06

(57) ABSTRACT

Embodiments of the present disclosure relate to an information transmission method and apparatus, a communication device, and a storage medium. A network slice admission control function (NSACF) determines, according to specific area indication information, statistical information of a session created within a specific area range of a network slice.

### CROSS REFERENCE TO RELATED APPLICATIONS

The present application is a U.S. national phase of International Application No. PCT/CN2022/072180, filed on Jan. 14, 2022, the disclosure of which is incorporated herein by reference in its entirety.

### TECHNICAL FIELD

The present disclosure relates to but is not limited to the field of wireless communication technologies, and in particular to information transmission methods and apparatuses, a communication device and a storage medium.

### BACKGROUND

A network slice can provide complete network functions, for example, radio access network functions, core network functions and Internet protocol multimedia subsystem (IMS) functions. A network can support one or more network slices. The network slices can provide different committed services and can be dedicated to specific users. Slices with the same service or slice but different slice differentiators may have different single network slice selection assistance information (S-NSSAI).

A mobile network operator (MNO) can deploy multiple network slices that provide the same function. The network slices can be divided into different user equipment (UE) groups. The network slices can provide different committed services and/or be dedicated to customers, respectively. Different network slices with the same slice function have different S-NSSAI, or service types of the network slices may be the same but the slice differentiators may be different.

### SUMMARY

According to a first aspect of the embodiments of the present disclosure, there is provided an information transmission method, performed by a network slice admission control function (NSACF), including: determining statistical information of one or more sessions created within a specific area range based on one or more network slices according to specific area indication information.

According to a second aspect of the embodiments of the present disclosure, there is provided an information transmission method, performed by a session management function (SMF), including: sending a statistical information update request, wherein the statistical information update request is configured to indicate a network slice admission control function (NSACF) to determine statistical information of one or more sessions created within a specific area range based on one or more network slices according to specific area indication information.

According to a third aspect of the embodiments of the present disclosure, there is provided a communication device including a processor, a memory and an executable program stored on the memory and executable by the processor, wherein the processor performs the steps of the information transmission method according to the first aspect or the second aspect when running the executable program.

According to a fourth aspect of the embodiments of the present disclosure, there is provided a storage medium having an executable program stored thereon, wherein the steps of the information transmission method according to the first aspect or the second aspect are implemented when the executable program is executed by a processor.

According to the information transmission methods, the communication device and the storage medium provided by the embodiments of the present disclosure, NSACF determines statistical information of one or more sessions created within a specific area range based on one or more network slices according to specific area indication information. In this way, compared with only determining statistical information of a whole network slice, by determining statistical information of the sessions created within the specific area range based on the network slices, NSACF can obtain the statistical information of the specific area with a granularity smaller than that of the whole network slice, and then manage network resources based on the statistical information within the specific area range, thereby meeting requirements of refined management of network operations and services.

It is understood that the foregoing general description and the following detailed description are only illustrative and explanatory, and are not intended to limit the embodiments of the present disclosure.

### BRIEF DESCRIPTION OF THE DRAWINGS

The accompanying drawings, which are incorporated in and constitute a part of this specification, illustrate embodiments consistent with the present disclosure and together with the specification serve to explain principles of embodiments of the present disclosure.

FIG. 1 is a schematic structural diagram illustrating a wireless communication system according to an exemplary embodiment.

FIG. 2 is a schematic flowchart illustrating an information transmission method according to an exemplary embodiment.

FIG. 3 is a schematic flowchart illustrating another information transmission method according to an exemplary embodiment.

FIG. 4 is a schematic flowchart illustrating yet another information transmission method according to an exemplary embodiment.

FIG. 5 is a schematic flowchart illustrating yet another information transmission method according to an exemplary embodiment.

FIG. 6 is a schematic flowchart illustrating yet another information transmission method according to an exemplary embodiment.

FIG. 7 is a schematic flowchart illustrating yet another information transmission method according to an exemplary embodiment.

FIG. 8 is a schematic flowchart illustrating yet another information transmission method according to an exemplary embodiment.

FIG. 9 is a schematic flowchart illustrating yet another information transmission method according to an exemplary embodiment.

FIG. 10 is a block diagram illustrating an information transmission apparatus according to an exemplary embodiment.

FIG. 11 is a block diagram illustrating another information transmission apparatus according to an exemplary embodiment.

FIG. 12 is a block diagram illustrating a device for information transmission according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to embodiments of the present disclosure as recited in the appended claims.

Terms used in embodiments of the present disclosure are for describing some embodiments only, and are not intended to limit the embodiments of the present disclosure. As used in embodiments of the present disclosure and the appended claims, “a/an” and “the” in singular forms are also intended to include plural forms unless the context clearly indicates otherwise. It could also be understood that the term “and/or” as used herein refers to and includes any and all possible combinations of one or more associated listed items.

It could be understood that although the embodiments of the present disclosure may use the terms “first”, “second”, “third”, and the like, to describe various information, but the information is not limited to these terms. These terms are only used to distinguish information of the same type from each other. For example, without departing from the scope of embodiments of the present disclosure, first information may also be called second information, and similarly second information may also be called first information. Depending on the context, the word “if” as used herein may be interpreted as “upon” or “when” or “in response to determining”.

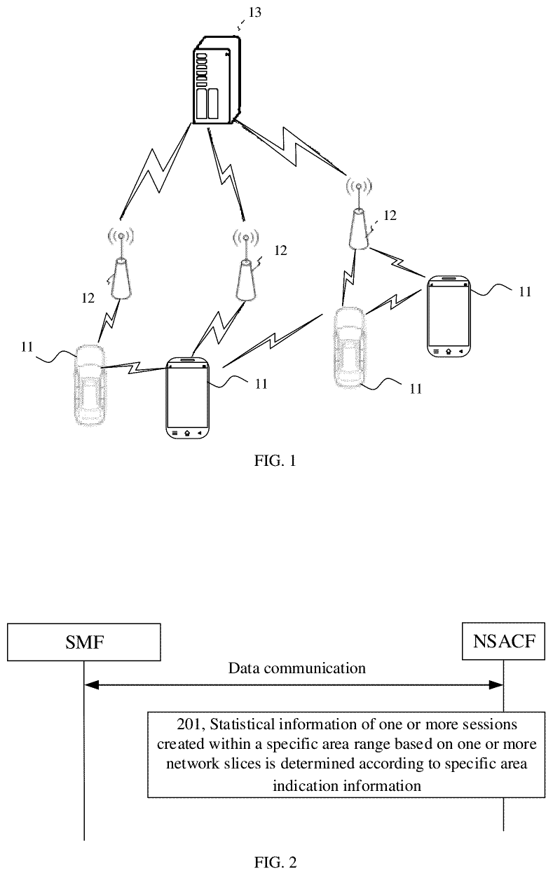

Referring to FIG. 1, FIG. 1 is a schematic structural diagram illustrating a wireless communication system according to an exemplary embodiment. As shown in FIG. 1, the wireless communication system is a communication system based on a cellular mobile communication technology, and the wireless communication system may include a plurality of terminals 11 and a plurality of base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or called a “cellular” phone) and a computer having an Internet of Things terminal. For example, the terminal 11 may be a fixed, portable, pocket, hand-held, built-in computer or vehicle-mounted device. For example, the terminal 11 may be a station (STA), a subscriber unit, a subscriber station, a mobile station, a mobile, a remote station, an access point, a remote terminal, an access terminal, a user terminal, a user agent, a user device, or user equipment (UE). Alternatively, the terminal 11 may be a device of an unmanned aerial vehicle. Alternatively, the terminal 11 may be a vehicle-mounted device, for example, a trip computer with a wireless communication function, or a wireless communication device externally connected to the trip computer. Alternatively, the terminal 11 may also be a roadside device, for example, it may be a street lamp, a signal lamp, or other roadside devices with a wireless communication function.

The base station 12 may be a network side device in a wireless communication system. The wireless communication system may be the fourth generation mobile communication technology (4G) system, also known as a long term evolution (LTE) system. Alternatively, the wireless communication system may also be the fifth generation mobile communication technology (5G) system, also called a new radio (NR) system or 5G NR system. Alternatively, the wireless communication system may also be a next generation system of the 5G system. An access network in the 5G system may be called a new generation-radio access network (NG-RAN). Alternatively, the wireless communication system may also be a machine type communication (MTC) system.

The base station 12 may be an evolved base station (eNB) adopted in a 4G system. Alternatively, the base station 12 may also be a central distributed architecture base station (gNB) in the 5G system. When the base station 12 adopts a central distributed architecture, the base station 12 generally includes a central unit (CU) and at least two distributed units (DU). The central unit is provided with a protocol stack of a packet data convergence protocol (PDCP) layer, a radio link control (RLC) layer, or a media access control (MAC) layer. A protocol stack of a physical (PHY) layer is provided in the distributed unit. The specific implementation manner of the base station 12 is not limited in the embodiments of the present disclosure.

A wireless connection may be established between the base station 12 and the terminal 11 through a wireless air interface. In some embodiments, the wireless air interface is a wireless air interface based on the fourth generation mobile communication network technology (4G) standard. Alternatively, the wireless air interface is a wireless air interface based on the fifth generation mobile communication network technology (5G) standard. For example, the wireless air interface is a new radio. Alternatively, the wireless air interface may also be a wireless air interface based on a next generation mobile communication network technology standard based on 5G.

In some embodiments, an E2E (end to end) connection may also be established between terminals 11, such as a V2V (vehicle to vehicle) communication, a V2I (vehicle to infrastructure) communication and a V2P (vehicle to pedestrian) communication in vehicle to everything (V2X) communication scenes.

In some embodiments, the above-mentioned wireless communication system may further include a network management device 13.

The plurality of base stations 12 are connected to the network management device 13 respectively. The network management device 13 may be a core network device in the wireless communication system. For example, the network management device 13 may be a core network device in the wireless communication system, for example, an access and mobility management function (AMF), a session management function (SMF), a user plane function (UPF), a policy control function (PCF), a network repository function (NRF), and the like. The implementation form of the network management device 13 is not limited in the embodiments of the present disclosure.

Execution subjects involved in the embodiments of the present disclosure include, but are not limited to, mobile phone terminals in a cellular mobile communication system, network-side devices, for example, access network devices such as base stations, and core networks.

It is necessary for application functions (AFs) and/or application service providers (ASPs) to obtain statistical information of one or more network slices based on requirements of user experience guarantee or promotion. The statistical information includes: a number of created sessions in the network slices, a number of activated protocol data unit (PDU) sessions, a ratio of the number of created sessions in the network slices and/or the number of activated PDU sessions to an overall threshold of the network slices, and the like.

Each of the network slices is supported by multiple network slice instances. For each public land mobile network (PLMN), a PDU session belongs to one and only one specific network slice instance, and different network slice instances do not share the PDU session.

In the related art, the statistical information for the network slices is based on the granularity of a whole network slice, that is, the statistical information is information of the coverage range of the whole network slice. The statistical information based on the whole network slice cannot really meet requirements of operators and services, especially service characteristics requirements in specific scenarios. Therefore, resources cannot be allocated according to network status to achieve a purpose of improving the service experience of the user.

For example, operators usually have an ability to flexibly allocate resources and guarantee business quality of service (QOS) in a specific area of the network slices, for example, provinces, cities, specific venues and schools. It is necessary for the operators to obtain specific statistical data such as the number of PDU sessions in the specific area to know and monitor real-time network conditions in the area. However, related technologies cannot meet the requirements of the operators for statistical data.

Therefore, how to count, perceive and monitor the number of PDU sessions in the specific area of the network slices to meet the requirements of operations and services in the specific area is an urgent problem to be solved.

As shown in FIG. 2, an exemplary embodiment of the present disclosure provides an information transmission method, which can be performed by a network slice admission control function (NSACF) of a cellular mobile communication system, including:
step 201, statistical information of one or more sessions created within a specific area range based on one or more network slices is determined according to specific area indication information.

Herein, the sessions may include, but are not limited to, the PDU sessions, and the like. One or more sessions created within a specific area range can be sessions that occupy resources within a specific area range of one or more network slices. Creating the sessions may include allocating resources for the sessions in the specific area.

The NSACF can be used to manage the sessions created within the network slices and the PDU sessions, for example, to control the number of PDU sessions created within the network slices. The NSACF can be the only NSACF deployed in the network slice, or the NSACF can also be one or more of multiple NSACFs deployed in the network slice.

In practical applications, the multiple NSACFs may be deployed in networks of the operators. A NSACF may serve one or more network slices in a service area. In one service area, one network slice is only processed by one NSACF. Herein, different network slices have different S-NSSAI. The NSACF can be a NSACF instance or a NSACF set. A PLMN can have one or more service areas.

The specific area indication information can be used to indicate one or more specific areas.

In one embodiment, network resources of a specific area are less than network resources of a whole network slice. That is, the specific area is less than a coverage range of whole network slice resources.

For example, a network slice can include N service areas, and a specific area can be one or M of the N service areas, where M is less than N and M and N are positive integers.

Statistical information can be statistical results of NSACF on sessions created within a specific area range of a network slice. The statistical information can include, but is not limited to, types of sessions created within a specific area range, a proportion of different types of sessions created within a specific area range, and the like.

In one embodiment, the statistical information includes a number of sessions created within the specific area range.

The NSACF can count a number of sessions created within the specific area range of the network slices. The NSACF can allocate corresponding resources based on the determined number of sessions, and can also control the sessions created within the specific area range of the network slices, for example, adjust the number of sessions created within the specific area range of the network slices, and thus the ability of flexible allocation of resources within the specific area range can be improved, and the quality of service (QOS) can be further improved.

The NSACF can trigger network slice admission control (NSAC) based on an external trigger mechanism, where NSAC can include: determining statistical information of the sessions created within the specific area range, and the like.

The NSACF can determine the number of sessions created within the specific area range based on an identifier (ID) of the sessions created within the specific area range.

In this way, compared with only determining statistical information of a whole network slice, by determining statistical information of the sessions created within the specific area range based on the network slices, NSACF can obtain the statistical information of the specific area with a granularity smaller than that of the whole network slice, and then manage network resources based on the statistical information within the specific area range, thereby meeting requirements of refined management of network operations and services.

In one embodiment, the specific area indication information includes at least one of:
a cell identifier (ID);
a tracking area ID (TAI);
an ID of an area of interest (AoI);
a TAI list;
an ID of a service area; or
an ID of a geography area.

Herein, there may be one or more cell IDs, TAIs, IDs of the AoI, TAI lists, IDs of the service area and/or IDs of the geography area. For example, the specific area indication information can include a plurality of cell IDs for indicating a plurality of cells.

The geographical area indicated by the ID of the geography area may be a geographical area that can be mapped to a service area, so that the NSACF can determine statistical information based on the mapped service area.

The NSACF can determine the statistical information of sessions created within the specific area range based on the specific area indication information, so as to realize session information statistics with smaller granularity relative to the whole network slice, thereby meeting requirements of refined management of network operations and services.

In one embodiment,
the specific area indication information is pre-stored in the NSACF; or,
the specific area indication information is determined based on a communication protocol; or,
the specific area indication information is received by the NSACF from a consumer network function.

The specific area indication information can be pre-stored in the NSACF, and when the NSACF is triggered, the specific area can be determined based on the pre-stored specific area indication information. The specific area indication information can also be determined according to the communication protocol, and when the NSACF is triggered, the specific area can be determined by the communication protocol or a calculation manner given in the communication protocol.

The consumer network function can include: a network exposure function (NEF), a policy decision function (PCF), an operation administration and maintenance system (OAM) and/or a master NSACF in multiple NSACF deployment scenarios.

The consumer network function can determine a specific area based on its own requirements, and indicate the specific area to the NSACF through specific area indication information.

In one embodiment, the method further includes:
sending the statistical information to a session management function (SMF).

The SMF is mainly responsible for interacting with separated data planes, creating, updating and deleting the PDU sessions, and managing a session environment with a user plane function (UPF). Herein, the SMF can be a SMF of an anchor session in a process of creating or releasing the session.

After determining the statistical information, the NSACF can feed back to the SMF for reference in making decisions. For example, the SMF can determine whether to create one or more new sessions within the specific area according to whether the number of sessions created within the specific area range exceeds a predetermined threshold.

In one embodiment, determining statistical information of the sessions created within the specific area range based on the network slices includes:
in response to receiving a statistical information update request of a session management function (SMF), determining the statistical information of the sessions created within the specific area range based on the network slices.

Determining, by the NSACF, the statistical information of the sessions created within the specific area range based on the network slices can be triggered by the SMF. An access and mobility management function (AMF) can be triggered by events such as creating a session by user equipment (UE), and send the statistical information update request to the NSACF to trigger the NSACF to execute the NSAC, so as to determine the statistical information.

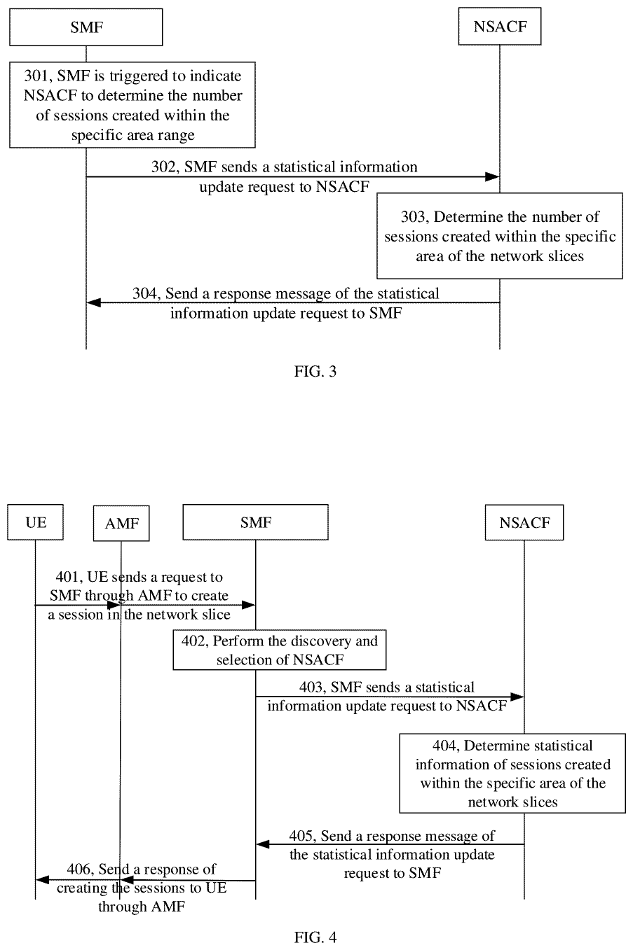

As shown in FIG. 3, determining, by the NSACF, the number of sessions created within the specific area range of the network slices according to the statistical information update request sent by the SMF includes the following steps.

Step 302, the NSACF receives the statistical information update request from the SMF to trigger the NSACF to determine the number of sessions created within the specific area of the network slices. For example, the statistical information update request can be Nnsacf_NSAC_NumOfPDUsUpdate_Request. The statistical information update request is used to indicate the NSACF to perform the validity check and update process of the sessions created within a slice specific area.

Step 303, the NSACF performs the validity check and update process of the sessions created within the slice specific area based on the statistical information update request, that is, determines the number of sessions created within the specific area of the network slices.

Step 304, the NSACF may send a response message of the statistical information update request to the SMF, and indicate to the SMF the determined number of sessions created within the specific area, and the like. For example, the response message of the statistical information update request can be: Nnsacf_NSAC_NumOfPDUsUpdate_Response.

In one embodiment, the statistical information update request is a statistical information update request generated by the SMF based on one or more session operations.

The session operations can include creating a session, changing a type of the session, and the like. For example, the session operations can include requesting an existing PDU session for Handover.

When a session operation for a network slice occurs, the statistical information update request is a statistical information update request sent by the SMF to the network slice corresponding to the session operation according to the network slice corresponding to the session operation.

In one embodiment, the session operations include:
one or more operations of creating the sessions based on the network slices.

The statistical information update request can explicitly or implicitly indicate an increase in the number of sessions. For example, when creating a session within a network slice, the statistical information update request can indicate an increase in the number of sessions with predetermined bits, or implicitly indicate an increase in the number of sessions with a session creation request as a statistical information update request.

When creating a session, the SMF can first perform the discovery of NSACF. For example, the SMF can determine a network slice for creation operation based on a slice identifier of creating the session, and then determine the NSACF corresponding to the network slice. Further, the SMF sends a statistical information update request to the determined NSACF. The slice identifier of the network slice can include S-NSSAI, and/or a slice differentiator, and the like.

The statistical information update request can be carried in operation information for operations of the network slice. For example, when creating a session in a network slice, the statistical information update request can be carried in the session creation request.

Creating the session in the network slice will cause changes in the statistical information of sessions created within the specific area, and thus the SMF can indicate the NSACF to determine the statistical information of sessions created within the specific area.

For example, for a scenario of creating a session in a network slice, the NSACF can determine the statistical information of sessions created within the specific area before the sessions are created in the network slice, and can also determine the statistical information of sessions created within the specific area after the sessions are created in the network slice.

As shown in FIG. 4, in the process of creating a session in a network slice, determining, by the NSACF, statistical information of sessions created within the specific area includes the following steps.

Step 403, the NSACF receives a statistical information update request sent by the SMF, for example, Nnsacf_NSAC_NumOfPDUsUpdate_Request. The statistical information update request is used to trigger the NSACF to determine the statistical information of the sessions created within the specific area of the network slices. The statistical information update request can indicate the NSACF to create one or more sessions in an explicit manner or an implicit manner.

The statistical information update request is determined by the SMF according to a request sent by UE received through the AMF, where the request is used to indicate the SMF to create one or more sessions in the network slices and trigger the SMF to initiate the validity check and update process of the number of sessions created within the specific area, and the request is used to indicate the SMF to perform the discovery and selection of the NSACF through local configuration information. If the SMF does not have an address of the NSACF, the SMF can find the NSACF through a network repository function (NRF). When the UE initiates a session creation, S-NSSAI of a network slice requesting the session creation can be carried in a session creation request sent by the UE, and the SMF can determine the NSACF based on at least the S-NSSAI. Alternatively, the SMF can also find the NSACF through the NRF.

For example, for a PDU session in a session and service continuity (SSC) mode 3, a SMF of a new PDU session calls the NSACF to increase a number of PDU sessions and add a new PDU session ID in the NSACF. When an old PDU session is released, a SMF of the old PDU session calls the NSACF to reduce the number of PDU sessions and delete an old PDU session ID in the NSACF.

The statistical information update request can include identifier information of the UE such as UE ID, a session ID, S-NSSAI of a network slice requesting to execute NSAC, an access type and an update flag. There may be one or more S-NSSAIs of the network slice requesting to execute NSAC, and the UE may request to create sessions in multiple network slices at the same time. The update flag can be used to indicate that sessions are created in the network slices, that is, the number of sessions is increased.

Step 404, the NSACF performs the validity check and update process of the number of sessions created within the slice specific area based on the statistical information update request, and determines statistical information of the sessions created within the specific area of the network slices, for example, the created number of sessions.

In response to creating the sessions in the network slices, the NSACF updates the number of sessions created in the network slices and confirms the number of sessions created within the specific area of the network slices.

In one embodiment, the NSACF can determine whether to allow creating one or more sessions based on the conditions of the network slices, for example, loads of the network slices, existing sessions in the slices, and the like.

Step 405, the NSACF sends a response message of the statistical information update request to the SMF according to the confirmed statistical information of the sessions created within the specific area of the network slices. The response message can include the determined number of sessions created within the specific area, and/or results of creating the sessions, and the like. The response message can be Nnsacf_NSAC_NumOfPDUsUpdate_Response, and the like. The response message can also be used to indicate the SMF to send a response of creating the sessions to the UE through the AMF.

In one embodiment, the session operations include one or more operations of releasing the sessions from the network slices.

In some embodiments, a session release request can be initiated by the UE. The UE can carry the session ID and the slice identifier of the network slice in the session release request. The session release request triggers the SMF to determine that the network slice needs to execute NSAC process, that is, triggers the network slice to perform the session number validity check and update process. The slice identifier of the network slice can include S-NSSAI, and/or a slice differentiator, and the like.

The SMF can send a statistical information update request to the NSACF to indicate the NSACF to determine the number of sessions created within the specific area of the network slices. The statistical information update request can explicitly or implicitly indicate a decrease in the number of sessions.

Releasing a session from a network slice will cause changes in the statistical information of sessions created within a specific area, and thus the SMFF can indicate the NSACF to determine the statistical information of sessions created within the specific area.

For example, the NSACF can determine the statistical information of the sessions created within the specific area after the sessions are released from the network slice.

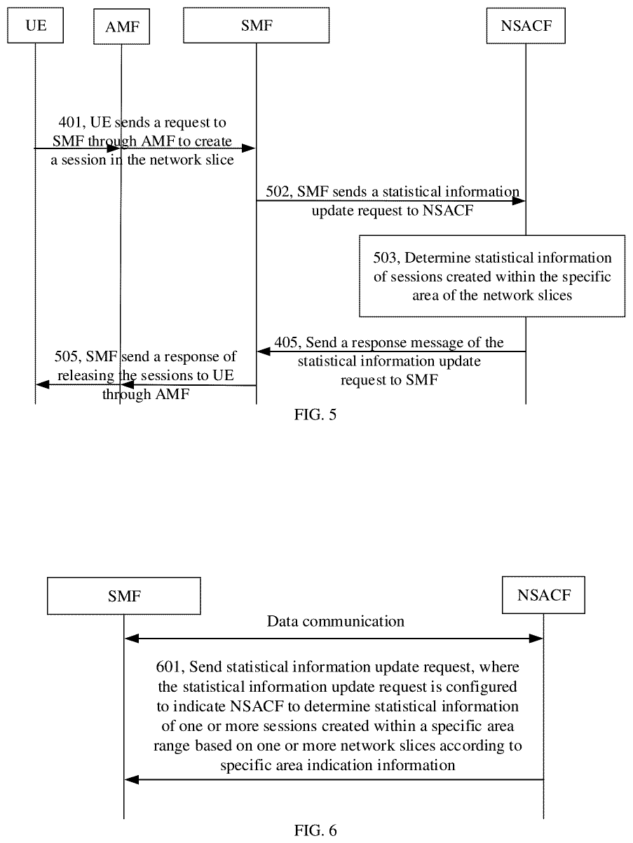

As shown in FIG. 5, in the process of releasing the sessions from the network slices, determining, by the NSACF, the statistical information of the sessions created within the specific area includes the following steps.

Step 502, the NSACF receives a statistical information update request sent by the SMF, for example, Nnsacf_NSAC_NumOfPDUsUpdate_Request. The statistical information update request is used to trigger the NSACF to determine the statistical information of the sessions created within the specific area of the network slices. The statistical information update request can indicate the NSACF to release one or more sessions in an explicit manner or an implicit manner. The statistical information update request can be determined by the SMF according to a sending request sent by UE through the AMF in the process of releasing the sessions from the network slices, where the request is used to indicate the SMF to create one or more sessions in the network slices and trigger the SMF to initiate the validity check and update process of the number of sessions created within the specific area. When the UE initiates a session release, S-NSSAI of a network slice requesting the session release can be carried in a session release request sent by the UE, and the SMF can determine the NSACF based on at least the S-NSSAI. Alternatively, the SMF can also find the NSACF through the NRF.

The statistical information update request can include identifier information of the UE such as UE ID, a session ID, S-NSSAI of a network slice requesting to execute NSAC, an access type and an update flag. There may be one or more S-NSSAIs of the network slice requesting to execute NSAC, and the UE may request to create sessions in multiple network slices at the same time. The update flag can be used to indicate that sessions are created in the network slices, that is, the number of sessions is decreased.

Step 503, the NSACF performs the validity check and update process of the number of sessions created within the slice specific area based on the statistical information update request, and determines statistical information of the sessions created within the specific area of the network slices, for example, the created number of sessions.

In response to releasing the sessions from the network slices, the NSACF updates the number of sessions created in the network slices and confirms the number of sessions created within the specific area of the network slices.

Step 504, the NSACF sends a response message of the statistical information update request to the SMF according to the confirmed statistical information of the sessions created within the specific area of the network slices. The response message can include the determined number of sessions created within the specific area, and/or results of creating the sessions, and the like. The response message can be Nnsacf_NSAC_NumOfPDUsUpdate_Response, and the like. The response message is used to indicate the SMF to send a response of releasing the sessions to the UE through the AMF.

In one embodiment, the statistical information update request carries service area information of the SMF and/or location information of the UE corresponding to the session operation, and
determining statistical information of the sessions created within the specific area range based on the network slices includes:
determining whether to count the sessions corresponding to the session operations in the statistical information based on the service area information of the SMF and/or the location information.

The UE corresponding to the session operation can include a UE requesting to perform the session operation. The location information can be used to indicate a location of the UE requesting the session operation. If locations of UEs requesting the session operations correspond to the specific area, the sessions corresponding to the session operations are counted; otherwise, the sessions corresponding to the session operations are not counted.

The UE corresponding to the session operation includes, but is not limited to, a UE requesting to create a session, a UE requesting to release the session, or a UE requesting to change a type of the session.

Herein, the location of the UE corresponding to the session operation corresponds to the specific area includes: the location of the UE corresponding to the session operation is within the specific area range, and the like.

For example, in step 404 shown in FIG. 4, the UE can create a session in a network slice. Since a specific area range is only a part of the whole network slice, the location where the UE is located may be outside the specific area range, and thus the NSACF may not count the session when determining statistical information of sessions created within the specific area range. If the location of the UE is within the specific area range, the session needs to be counted.

By determining whether to count the session according to the location information of the UE, the accuracy of the NSAC threshold in determining the statistical information can be improved.

The service area information of the SMF can be used to indicate a location of a SMF service area. If the location of the SMF service area corresponds to the specific area, the sessions corresponding to the session operations are counted: otherwise, the sessions corresponding to the session operations are not counted.

Herein, the location of the SMF service area corresponds to the specific area includes: the location of the SMF service area is within the specific area range, and the like.

In one embodiment, the service area information of the SMF includes user plane function (UPF) service area information corresponding to the SMF.

The UPF service area information can be used to indicate to provide one or more UPF service areas. If the UPF service areas are located in the specific area, the sessions corresponding to the session operations are counted: otherwise, the sessions corresponding to the session operations are not counted.

For example, in step 404 shown in FIG. 4, the UE can create a session in a network slice. Since a specific area range is only a part of the whole network slice, the location where the UPF service area is located may be outside the specific area range, and thus the NSACF may not count the session when determining statistical information of sessions created within the specific area range. If the location of the UPF service area is within the specific area range, the session needs to be counted.

By determining whether to count the session according to the service area information of the SMF, the accuracy of the NSAC threshold in determining the statistical information can be improved.

In one embodiment, the location information includes at least one of:
cell information; or
tracking area information.

The statistical information update request carries location information of the UE corresponding to the session operation, where the location information is at least one of the following information: cell information; or tracking area information.

In one embodiment, the location information of the UE that created the session can be sent to AMF by a base station (for example, gNB), then the AMF sends the location information to the SMF, and the SMF sends the location information carried in the statistical information update request to the NSACF. Alternatively, the location information can be obtained by the AMF from a gateway mobile location center (GMLC).

In one embodiment, the statistical information update request carries one or more slice identifiers (IDs), and
determining statistical information of the sessions created within the specific area range based on the network slices includes:
determining the statistical information of the sessions created within the specific area range based on the network slices indicated by the slice IDs.

The statistical information update request sent by the SMF received by the NSACF can carry one or more slice identifiers of the network slices for which statistical information needs to be determined. Herein, the slice identifier can include: S-NSSAI, a slice differentiator, and the like.

The NSACF can determine the network slices for which statistical information needs to be determined according to the slice identifiers. Since the NSACF can correspond to multiple network slices, the accuracy of the SMF indication can be improved by indicating the network slices using the slice identifiers.

In one embodiment, the specific area range of the network slices has a maximum number of sessions allowed to create sessions.

The NSACF can be configured with a maximum number of sessions created for a specific area, that is, a threshold of the maximum number of sessions created within a specific area range.

In the process of creating the sessions, if the number of sessions created in the current specific area of the network slices reaches the maximum number of sessions, the NSACF can refuse to create the sessions.

In one embodiment, in response to the number of sessions created in the network slices based on the request sent by the UE not reaching the maximum number of sessions, the NSACF checks a UE ID. If the UE ID already exists, the NSACF stores a session ID and increases the number of sessions of the network slices; and if the NSACF does not find the UE ID, the NSACF keeps the UE ID, stores the session ID corresponding to the UE at the same time, and increases the number of sessions of the network slices.

In one embodiment, the method further includes:
in response to a number of sessions created within the specific area range of the network slices reaching the maximum number of sessions, sending, by NSACF, reaching maximum number indication information indicating that the number of sessions created within the specific area range of the network slices reaches the maximum number of sessions to a session management function (SMF).

Herein, the number of sessions created within a specific area range reaches the maximum number of sessions can be that the number of sessions created within the specific area range is equal to the allowed maximum number of sessions.

In the process of creating the sessions by UEs, if the number of sessions created in the current specific area of the network slices reaches the maximum number of sessions, the NSACF can reject the request of creating the sessions sent by the UEs, and indicate the slice identifier of the network slice to the SMF through reaching maximum number indication information. The SMF can determine the reason for session creation failure. Meanwhile, the reaching maximum number indication information can include statistical information of the network slices, that is, the number of sessions created in the current network slice.

The SMF can send indication information to the UE through the AMF to indicate a slice identifier list of the network slices that refuse to create sessions, and can indicate the reason for refusing to create sessions for each of the network slices that refuses to create sessions, for example, the number of sessions created within the specific area of the network slices has reached the maximum number of sessions.

In one embodiment, the SMF can also set a timer for the UE to initiate a re-request to create a session. When the timer expires, the SMF can initiate the session creation request of the network slices again.

As shown in FIG. 6, an exemplary embodiment of the present disclosure provides an information transmission method, which can be performed by a session management function (SMF) of a cellular mobile communication system, including:
step 601, a statistical information update request is sent to a network slice admission control function (NSACF), where the statistical information update request is configured to indicate the NSACF to determine statistical information of one or more sessions created within a specific area range based on one or more network slices according to specific area indication information.

The SMF is mainly responsible for interacting with separated data planes, creating, updating and deleting the PDU sessions, and managing a session environment with a user plane function (UPF). Herein, the SMF can be a SMF of an anchor session in a process of creating or releasing the session.

Herein, the sessions may include, but are not limited to, PDU sessions, and the like. One or more sessions created within a specific area range can be sessions that occupy resources within a specific area range of one or more network slices. Creating the sessions may include allocating resources for the sessions in the specific area.

The NSACF can be used to manage the sessions created within the network slices and the PDU sessions, for example, to control the number of PDU sessions created within the network slices. The NSACF can be the only NSACF deployed in the network slice, or the NSACF can also be one or more of multiple NSACFs deployed in the network slice.

In practical applications, the multiple NSACFs may be deployed in networks of the operators. A NSACF may serve one or more network slices in a service area. In one service area, one network slice is only processed by one NSACF. Herein, different network slices have different S-NSSAI. The NSACF can be a NSACF instance or a NSACF set. A PLMN can have one or more service areas.

The specific area indication information can be used to indicate one or more specific areas.

In one embodiment, network resources of a specific area are less than network resources of a whole network slice. That is, the specific area is less than a coverage range of whole network slice resources.

For example, a network slice can include N service areas, and a specific area can be one or M of the N service areas, where M is less than N and M and N are positive integers.

Statistical information can be statistical results of NSACF on sessions created within a specific area range of a network slice. The statistical information can include, but is not limited to, types of sessions created within a specific area range, a proportion of different types of sessions created within a specific area range, and the like.

In one embodiment, the statistical information includes a number of sessions created within the specific area range.

The NSACF can count a number of sessions created within the specific area range of the network slices. The NSACF can allocate corresponding resources based on the determined number of sessions, and can also control the sessions created within the specific area range of the network slices, for example, adjust the number of sessions created within the specific area range of the network slices, and thus the ability of flexible allocation of resources within the specific area range can be improved, and the quality of service (QoS) can be further improved.

The NSACF can trigger network slice admission control (NSAC) based on an external trigger mechanism, where NSAC can include: determining statistical information of the sessions created within the specific area range, and the like.

The NSACF can determine the number of sessions created within the specific area range based on an identifier (ID) of the sessions created within the specific area range.

Determining, by the NSACF, the statistical information of the sessions created within the specific area range based on the network slices can be triggered by the SMF. An access and mobility management function (AMF) can be triggered by events such as creating a session by user equipment (UE), and send the statistical information update request to the NSACF to trigger the NSACF to execute the NSAC, so as to determine the statistical information.

As shown in FIG. 3, the SMF indicates the NSACF to determine a number of sessions created within a specific area range of one or more network slices through a statistical information update request. The specific steps are as follows.

Step 301, the SMF is triggered to indicate the NSACF to determine the number of sessions created within the specific area range, that is, the SMF is triggered to indicate the NSACF to perform the validity check and update process of one or more sessions created within a slice specific area.

Step 302, the SMF sends a statistical information update request to the NSACF to trigger the NSACF to determine the number of sessions created within the specific area of the network slices. For example, the statistical information update request can be Nnsacf_NSAC_NumOfPDUsUpdate_Request. The statistical information update request is used to indicate the NSACF to perform the validity check and update process of the sessions created within a slice specific area based on the statistical information update request, that is, to determine the number of sessions created within the specific area of the network slices.

Step 304, the SMF receives a response message of the statistical information update request sent by the NSACF, and indicates to the SMF the determined number of sessions created within the specific area, and the like. For example, the response message of the statistical information update request can be: Nnsacf_NSAC_NumOfPDUsUpdate_Response.

In this way, compared with only determining statistical information of a whole network slice, by determining statistical information of the sessions created within the specific area range based on the network slices, NSACF can obtain the statistical information of the specific area with a granularity smaller than that of the whole network slice, and then manage network resources based on the statistical information within the specific area range, thereby meeting requirements of refined management of network operations and services.

In one embodiment, the specific area indication information includes at least one of:
a cell identifier (ID);
a tracking area ID (TAI);
an ID of an area of interest (AoI);
a TAI list;
an ID of a service area; or
an ID of a geography area.

Herein, there may be one or more cell IDs, TAIs, IDs of the AoI, TAI lists, IDs of the service area and/or IDs of the geography area. For example, the specific area indication information can include a plurality of cell IDs for indicating a plurality of cells.

The geographical area indicated by the ID of the geography area may be a geographical area that can be mapped to a service area, so that the NSACF can determine statistical information based on the mapped service area.

The NSACF can determine the statistical information of sessions created within the specific area range based on the specific area indication information, so as to realize session information statistics with smaller granularity relative to the whole network slice, thereby meeting requirements of refined management of network operations and services.

In one embodiment, the specific area indication information is pre-stored in the NSACF; or,
the specific area indication information is determined based on a communication protocol; or,
the specific area indication information is sent to the NSACF by a consumer network function.

The specific area indication information can be pre-stored in the NSACF, and when the NSACF is triggered, the specific area can be determined based on the pre-stored specific area indication information.

The consumer network function can include: a network exposure function (NEF), a policy decision function (PCF), an operation administration and maintenance system (OAM) and/or a master NSACF in multiple NSACF deployment scenarios.

The consumer network function can determine a specific area based on its own requirements, and indicate the specific area to the NSACF through specific area indication information.

In one embodiment, the method further includes:
receiving the statistical information sent by the NSACF.

After determining the statistical information, the NSACF can feed back to the SMF for reference in making decisions. For example, the SMF can determine whether to create one or more new sessions within the specific area according to whether the number of sessions created within the specific area range exceeds a predetermined threshold.

In one embodiment, the statistical information update request includes:
one or more statistical information update requests corresponding one or more session operations.

The session operations can include creating a session, changing a type of the session, and the like. For example, the session operations can include requesting an existing PDU session for Handover.

When a session operation for a network slice occurs, the SMF can first determine the network slice corresponding to the session operation, and send a statistical information update request to the network slice corresponding to the session operation.

In one embodiment, the session operations include:
one or more operations of creating the sessions based on the network slices.

The statistical information update request can explicitly or implicitly indicate an increase in the number of sessions. For example, when creating a session within a network slice, the statistical information update request can indicate an increase in the number of sessions with predetermined bits, or implicitly indicate an increase in the number of sessions with a session creation request as a statistical information update request.

When creating a session, the SMF can first perform the discovery of NSACF. For example, the SMF can determine a network slice for creation operation based on a slice identifier of creating the session, and then determine the NSACF corresponding to the network slice. Further, the SMF sends a statistical information update request to the determined NSACF. The slice identifier of the network slice can include S-NSSAI, and/or a slice differentiator, and the like.

The statistical information update request can be carried in operation information for operations of the network slice. For example, when creating a session in a network slice, the statistical information update request can be carried in the session creation request.

Creating the session in the network slice will cause changes in the statistical information of sessions created within the specific area, and thus the SMF can indicate the NSACF to determine the statistical information of sessions created within the specific area.

For example, for a scenario of creating a session in a network slice, the NSACF can determine the statistical information of sessions created within the specific area before the sessions are created in the network slice, and can also determine the statistical information of sessions created within the specific area after the sessions are created in the network slice.

As shown in FIG. 4, in the process of creating a session in a network slice, the SMF indicates the NSACF to determine statistical information of sessions created within the specific area includes the following steps.

Step 402, the SMF receives a request for creating a session in a network slice sent by UE through the AMF. The request is used to trigger the SMF to initiate the validity check and update process of the number of sessions created within the specific area.

The SMF can perform the discovery and selection of the NSACF through local configuration information. If the SMF does not have an address of the NSACF, the SMF can find the NSACF through a network repository function (NRF).

When the UE initiates a session creation, S-NSSAI of a network slice requesting the session creation can be carried in a session creation request sent by the UE, and the SMF can determine the NSACF based on at least the S-NSSAI. Alternatively, the SMF can also find the NSACF through the NRF.

For example, for a PDU session in a session and service continuity (SSC) mode 3, a SMF of a new PDU session calls the NSACF to increase a number of PDU sessions and add a new PDU session ID in the NSACF. When an old PDU session is released, a SMF of the old PDU session calls the NSACF to reduce the number of PDU sessions and delete an old PDU session ID in the NSACF.

Step 403, the SMF sends a statistical information update request to the NSACF, for example, Nnsacf_NSAC_NumOfPDUsUpdate_Request, to trigger the NSACF to determine the statistical information of sessions created within the specific area of the network slices. The statistical information update request can indicate the NSACF to create a session in an explicit manner or an implicit manner.

The statistical information update request can include identifier information of the UE such as UE ID, a session ID, S-NSSAI of a network slice requesting to execute NSAC, an access type and an update flag. There may be one or more S-NSSAIs of the network slice requesting to execute NSAC, and the UE may request to create sessions in multiple network slices at the same time. The update flag can be used to indicate that sessions are created in the network slices, that is, the number of sessions is increased.

Step 405, the SMF receives a response message of the statistical information update request sent by the NSACF. The response message can include the determined number of sessions created within the specific area, and/or results of creating the sessions, and the like. The response message can be Nnsacf_NSAC_NumOfPDUsUpdate_Response, and the like. The response message of the statistical information update request is sent by the NSACF according to the confirmed statistical information of the sessions created within the specific area of the network slices. The response message of the statistical information update request is determined by the NSACF based on the statistical information update request to perform the validity check and update process of the number of sessions created within the slice specific area, and to determine the statistical information of the sessions created within the specific area of the network slices (for example, the created number of sessions, and the like). In response to creating the sessions in the network slices, the NSACF updates the number of sessions created in the network slices, and confirms the number of sessions created within the specific area of the network slices. In one embodiment, the NSACF can determine whether to allow creating one or more sessions based on the conditions of the network slices, for example, loads of the network slices, existing sessions in the slices, and the like.

Step 406, the SMF can send a response of creating the sessions to the UE through the AMF.

In one embodiment, the session operations include: one or more operations of releasing the sessions from the network slices.

A session release request can be initiated by the UE. The UE can carry the session ID and the slice identifier of the network slice in the session release request. The session release request triggers the SMF to determine that the network slice needs to execute NSAC process, that is, triggers the network slice to perform the session number validity check and update process. The slice identifier of the network slice can include S-NSSAI, and/or a slice differentiator, and the like.

The SMF can send a statistical information update request to the NSACF to indicate the NSACF to determine the number of sessions created within the specific area of the network slices. The statistical information update request can explicitly or implicitly indicate a decrease in the number of sessions.

Releasing a session from a network slice will cause changes in the statistical information of sessions created within a specific area, and thus the SMFF can indicate the NSACF to determine the statistical information of sessions created within the specific area.

For example, the NSACF can determine the statistical information of the sessions created within the specific area after the sessions are released from the network slice.

As shown in FIG. 5, in the process of releasing the sessions from the network slices, sending, by the SMF, a statistical information update request to the NSACF to trigger the NSACF to determine the statistical information of the sessions created within the specific area include the following steps.

Step 502, the SMF sends a statistical information update request to the NSACF, for example, Nnsacf_NSAC_NumOfPDUsUpdate_Request, to trigger the NSACF to determine the statistical information of sessions created within the specific area of the network slices. The statistical information update request can indicate the NSACF to release a session in an explicit manner or an implicit manner. The statistical information update request is determined by the SMF according to a request of releasing the sessions from the network slices sent by UE received through the AMF, where the request is used to trigger the SMF to initiate the validity check and update process of the number of sessions created within the specific area.

When the UE initiates a session release, S-NSSAI of a network slice requesting the session release can be carried in a session release request sent by the UE, and the SMF can determine the NSACF based on at least the S-NSSAI. Alternatively, the SMF can also find the NSACF through the NRF.

The statistical information update request can include identifier information of the UE such as UE ID, a session ID, S-NSSAI of a network slice requesting to execute NSAC, an access type and an update flag. There may be one or more S-NSSAIs of the network slice requesting to execute NSAC, and the UE may request to create sessions in multiple network slices at the same time. The update flag can be used to indicate that sessions are created in the network slices, that is, the number of sessions is decreased.

Step 504, the SMF receives a response message of the statistical information update request sent by the NSACF. The response message can include the determined number of sessions created within the specific area, and/or results of creating the sessions, and the like. The response message can be Nnsacf_NSAC_NumOfPDUsUpdate_Response, and the like. The response message of the statistical information update request is determined by the NSACF according to the confirmed statistical information of the sessions created within the specific area of the network slices. That is, the NSACF performs the validity check and update process of the number of sessions created within the slice specific area based on the statistical information update request, and determines the statistical information of the sessions created within the specific area of the network slices, for example, the created number of sessions. In response to releasing the sessions from the network slices, the NSACF updates the number of sessions created in the network slice and confirms the number of sessions created within the specific area of the network slices.

Step 505, the SMF can send a response of releasing the sessions to the UE through the AMF.

In one embodiment, the statistical information update request carries service area information of the SMF and/or location information of the UE corresponding to the session operation,
the location information is configured for the NSACF to determine whether to count the sessions corresponding to the session operations in the statistical information.

The UE corresponding to the session operation can include UE requesting to perform the session operation. The location information can be used to indicate a location of the UE requesting the session operation. If locations of UEs requesting the session operations correspond to the specific area, the sessions corresponding to the session operations are counted; otherwise, the sessions corresponding to the session operations are not counted.

The UE corresponding to the session operation includes, but is not limited to, a UE requesting to create a session, a UE requesting to release the session, or a UE requesting to change a type of the session.

Herein, the location of the UE corresponding to the session operation corresponds to the specific area includes: the location of the UE corresponding to the session operation is within the specific area range, and the like.

For example, in step 404 shown in FIG. 4, the UE can create a session in a network slice. Since a specific area range is only a part of the whole network slice, the location where the UE is located may be outside the specific area range, and thus the NSACF may not count the session when determining statistical information of sessions created within the specific area range. If the location of the UE is within the specific area range, the session needs to be counted.

By determining whether to count the session according to the location information of the UE, the accuracy of the NSAC threshold in determining the statistical information can be improved.

The service area information of the SMF can be used to indicate a location of a SMF service area. If the location of the SMF service area corresponds to the specific area, the sessions corresponding to the session operations are counted; otherwise, the sessions corresponding to the session operations are not counted.

Herein, the location of the SMF service area corresponds to the specific area includes: the location of the SMF service area is within the specific area range, and the like.

In one embodiment, the service area information of the SMF includes user plane function (UPF) service area information corresponding to the SMF.

The UPF service area information can be used to indicate to provide one or more UPF service areas. If the UPF service areas are located in the specific area, the sessions corresponding to the session operations are counted; otherwise, the sessions corresponding to the session operations are not counted.

For example, in step 404 shown in FIG. 4, the UE can create a session in a network slice. Since a specific area range is only a part of the whole network slice, the location where the UPF service area is located may be outside the specific area range, and thus the NSACF may not count the session when determining statistical information of sessions created within the specific area range. If the location of the UPF service area is within the specific area range, the session needs to be counted.

By determining whether to count the session according to the service area information of the SMF, the accuracy of the NSAC threshold in determining the statistical information can be improved.

In one embodiment, the location information includes at least one of:
cell information; or
tracking area information.

The statistical information update request carries location information of the UE corresponding to the session operation, where the location information is at least one of the following information: cell information; or tracking area information.

In one embodiment,
the location information is received from an access and mobility management function (AMF); and/or,
the location information is obtained from a gateway mobile location center (GMLC).

In one embodiment, the location information of the UE that created the session can be sent to AMF by a base station (for example, gNB), then the AMF sends the location information to the SMF, and the SMF sends the location information carried in the statistical information update request to the NSACF. Alternatively, the location information can be obtained by the AMF from a gateway mobile location center (GMLC).

In one embodiment, the statistical information update request carries one or more slice identifiers (IDs); and
the statistical information update request is configured to indicate the NSACF to determine the statistical information of the sessions created within the specific area range based on the network slices indicated by the slice IDs.

The statistical information update request sent by the SMF to the NSACF can carry one or more slice identifiers of the network slices for which statistical information needs to be determined. Herein, the slice identifier can include: S-NSSAI, a slice differentiator, and the like.

The NSACF can determine the network slices for which statistical information needs to be determined according to the slice identifiers. Since the NSACF can correspond to multiple network slices, the accuracy of the SMF indication can be improved by indicating the network slices using the slice identifiers.

In one embodiment, the specific area range of the network slices has a maximum number of sessions allowed to create sessions, and
the method further includes:
receiving reaching maximum number indication information, wherein the reaching maximum number indication information is configured to indicate that the number of sessions created within the specific area range reaches the maximum number of sessions.

Herein, the number of sessions created within a specific area range reaches the maximum number of sessions can be that the number of sessions created within the specific area range is equal to the allowed maximum number of sessions.

The NSACF can be configured with a maximum number of sessions created for a specific area, that is, a threshold of the maximum number of sessions created within a specific area range.

In the process of creating the sessions, if the number of sessions created in the current specific area of the network slices reaches the maximum number of sessions, the NSACF can refuse to create the sessions.

In one embodiment, in response to the number of sessions created in the network slices based on the request sent by the UE not reaching the maximum number of sessions, the NSACF checks a UE ID. If the UE ID already exists, the NSACF stores a session ID and increases the number of sessions of the network slices; and if the NSACF does not find the UE ID, the NSACF keeps the UE ID, stores the session ID corresponding to the UE at the same time, and increases the number of sessions of the network slices.

In the process of creating the sessions by UEs, if the number of sessions created in the current specific area of the network slices reaches the maximum number of sessions, the NSACF can reject the request of creating the sessions sent by the UEs, and indicate the slice identifier of the network slice to the SMF through reaching maximum number indication information. The SMF can determine the reason for session creation failure. Meanwhile, the reaching maximum number indication information can include statistical information of the network slices, that is, the number of sessions created in the current network slice.

In one embodiment, the method further includes:
in response to receiving the reaching maximum number indication information, stopping creating the sessions in the network slices indicated by one or more slice identifiers (IDs).

The SMF can send indication information to the UE through the AMF to indicate a slice identifier list of the network slices that refuse to create sessions, and can indicate the reason for refusing to create sessions for each of the network slices that refuses to create sessions, for example, the number of sessions created within the specific area of the network slices has reached the maximum number of sessions.

In one embodiment, the SMF can also set a timer for the UE to initiate a re-request to create a session. When the timer expires, the SMF can initiate the session creation request of the network slices again.

Three specific examples are provided below in connection with any of the above embodiments.

The statistical method of the number of sessions created within the specific area of the network slices includes the following contents.
1. In the process of creating one or more sessions or releasing the sessions, the NSACF performs statistics on the number of sessions created based on the specific area information of the slice, and increases or decreases the number of sessions created within the specific area of the slice.
2. The specific area information is at least one of the following information: a cell identifier (ID), a tracking area ID (TAI), an area of interest (AoI), a TAI list, a service area, a geography area that can be mapped to the service area.
3. The specific area information is configured on the NSACF, or provided to the NSACF by one of the following consumer network functions: a network exposure function (NEF), a policy decision function (PCF), a master NSACF in multiple NSACF deployed scenarios in the slices, and/or configured to the NSACF through an operation administration and maintenance system (OAM).
4. The NSACF performs statistics on the number of sessions created within the specific area of the slice according to SMF service area information.
5. The SMF service area information is all UPF service area information corresponding to the SMF, or one or more UPF service area information corresponding to the SMF.
6. The SMF service area information is obtained from the SMF and carried in the request message sent by the SMF to the NSACF.
7. The NSACF performs statistics on the number of sessions created within the specific area of the slice according to location information of users who created the sessions.
8. The location information of the users who created the sessions is at least one of the following information: cell information or tracking area information.
9. The location information of the users who created the sessions is obtained from the SMF and carried in the request message sent by the SMF to the NSACF.
10. The location information of the users who created the sessions is obtained by the SMF from the AMF or the GMLC.
11. After receiving a request message for updating the number of sessions created in the slices, the NSACF updates the number of sessions created within the specific area of the slice.
12. The NSACF updates the number of sessions created within the specific area of the slice according to the location information of the users who created the sessions and/or the SMF service area information carried in the request message sent by the SMF.
13. The NSACF is the only NSACF deployed in the slices, or a certain NSACF of a plurality of NSACFs deployed the slice.
14. The NSACF is configured with the maximum number of creation sessions allowed in a specific area of a slice, or a creation session allowable threshold within a specific area of a slice.
15. When the number of sessions created within a specific area of a slice reaches the maximum number of created sessions or an allowable threshold, the response message sent by the NSACF to the SMF carries the slice identifier S-NSSAI(s) that the number of sessions created within the specific area of the slice has reached the set threshold/maximum value and result parameters indicating that the maximum value has been reached.

### Example 1

The example provides a specific example of the validity check and update process of a number of sessions created within a specific area of network slices.

The availability check and update process of the specific area of the network slices are used to update (that is, increase or decrease) a number of PDU sessions created in the corresponding area on the slice (the corresponding slice is configured with a NSAC process to be executed). A session management function SMF is configured with information indicating which network slice or slices need to perform the NSAC process.

Specific area information can be configured on the NSACF, or provided to the NSACF by consumer network functions in 5G network (for example, a network opening function (NEF), or a policy decision function (PCF), or a main NSACF when multiple NSACF deploy scenarios), or configured to the NSACF through an operation administration and maintenance system (OAM).

The NSACF in the process is suitable for the only NSACF scenario deployed in the slices, or the scenario with a certain NSACF among multiple NSACF deployed in the slices.

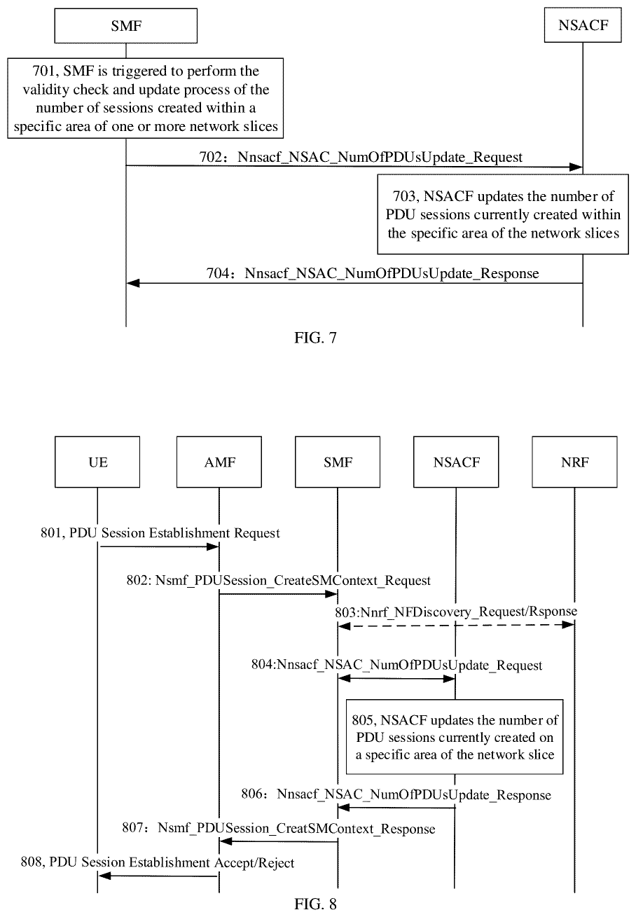

As shown in FIG. 7, the process of performing the validity check and update process of the number of sessions created within the specific area of the slices specifically includes the following steps.

Step 701, the SMF is triggered to perform the validity check and update process of the number of sessions created within a specific area of one or more network slices.

If the SMF does not know a peer NSACF, the SMF first performs the discovery and selection of the NSACF. The SMF (a SMF for anchoring PDU session) triggers the validity check and update process for the number of sessions within the specific area of the slices. The trigger condition of the process can be that the SMF triggers the process for slices that need to perform the NSAC at the beginning of a PDU session creation process or after a PDU session is successfully released.

Herein, slice specific area information performed by the NSACF can be at least one of the following information: a cell identifier (ID), a tracking area ID (TAI), an area of interest (AoI), a TAI list, a service area, a geography area that can be mapped to the service area.

For an existing PDU session whose session request type is Handover, the process is also applicable, but the interactive update with the NSAC may not be performed for the creation of the existing session type based on policies of the operators.

Step 702, the SMF (the SMF for anchoring PDU session) sends a request message Nnsacf_NSAC_NumOfPDUsUpdate_Request to the NSACF, where the request message carries a UE-ID, a session ID, a slice identifier or an identifier list S-NSSAI(s) of the slices that need to perform the NSAC, an access type and an update flag. The update flag is used to mark whether the number of sessions is increased or decreased. For example, the number of sessions is increased in the process of creating the sessions and is decreased after the process of releasing the sessions.

For a PDU session in a session and service continuity (SSC) mode 3, a SMF of a new PDU session calls the NSACF to increase a number of PDU sessions and add a new PDU session ID in the NSACF. When an old PDU session is released, a SMF of the old PDU session calls the NSACF to reduce the number of PDU sessions and delete an old PDU session ID in the NSACF.

Optionally, the SMF also carries the SMF service area information in the request message. The SMF service area information is all UPF service area information corresponding to the SMF, or one or more UPF service area information corresponding to the SMF. The SMF service area information is obtained from the SMF and carried in the request message sent by the SMF to the NSACF.

Optionally, the SMF also carries location information of the UE that created the sessions in the request message. The location information of the UE is at least one of the following information: cell information or tracking area information. The location information of the UE creating the sessions is obtained by the SMF from the AMF or the GMLC, and is carried in the request message sent by the SMF to the NSACF.

Step 703, the NSACF updates the number of PDU sessions currently created within the specific area of the network slices. For example, the corresponding session increase or decrease is performed on the session anchor SMF based on update flag parameters.

If the update flag is increased and the maximum number of PDU sessions created on the slice S-NSSAI has been reached, the NSACF returns a result parameter indicating that the maximum number of PDU sessions for the slice has been reached; and if the maximum number of PDU sessions allowed to create by the slices is not reached, the NSACF checks the UE ID. If the UE ID already exists, the NSACF stores the Session ID and increases the number of sessions of the network slices; and if the NSACF does not find the UE ID, the NSACF keeps the UE ID, stores the Session ID corresponding to the UE at the same time, and increases the number of sessions of the network slices.

If the update flag is reduced, the NSACF finds the UE ID, reduces the number of sessions of the slices, and deletes the Session ID. If this is the last session of the terminal, the NSACF will delete the UE ID from the list after deducting the number of sessions in the slices.

Optionally, the NSACF is configured with the maximum number of creation sessions allowed in a specific area of a slice, or a creation session allowable threshold within a specific area of a slice. When the NSAC is executed for a slice specific area, if the number of sessions created within the slice specific area reaches the maximum number of creation sessions or the allowable threshold, the response message sent by the NSACF to the SMF carries the slice identifier S-NSSAI(s) that the number of sessions created within the specific area of the slice has reached the set threshold/maximum value and result parameters indicating that the maximum value has been reached.

Step 704, the NSACF confirms corresponding update by returning a corresponding message Nnsacf_NSAC_NumOfPDUsUpdate_Response to the SMF. If the number of created sessions returned by the NSACF for the slice has reached the maximum allowable value, the SMF may reject a session establishment request in combination with policies of the operators, and a rejection reason is set to “Number of sessions allowed for the slice has reached”. At the same time, a back-off timer is provided optionally. If the session creation fails in the subsequent process, the SMF will trigger the interaction with NSACF again, deduct the corresponding number of sessions and update the response information.

### Example 2

As shown in FIG. 8, in the process of creating a UE session to a network slice, the specific steps of performing the validity check and update process of the number of sessions created within a slice specific area include:
step 801 to step 802, the UE requests to create a session a certain network slice. The SMF triggers the validity check and update process of the number of sessions in the corresponding area of the slice.

Specifically, step 801, UE sends a PDU session establishment request to AMF.

Step 802, the AMF requests the SMF to create a PDU session for the UE through a command Nsmf_PDUSession_CreateSMContext_Request.

Step 803, the SMF can perform the discovery and selection of the NSACF through local configuration information. If the SMF does not have an address of the NSACF, the NSACF may find the NSACF through the NRF.

Specific contents of step 804 to step 806 respectively correspond to the specific contents of step 702 to step 704 shown in FIG. 7 in Example 1, which will not be repeated here.

Step 807 to step 808, the SMF sends corresponding session creation response messages to the AMF and the UE based on the corresponding messages returned by the NSACF, and accepts or rejects the session creation.

### Example 3

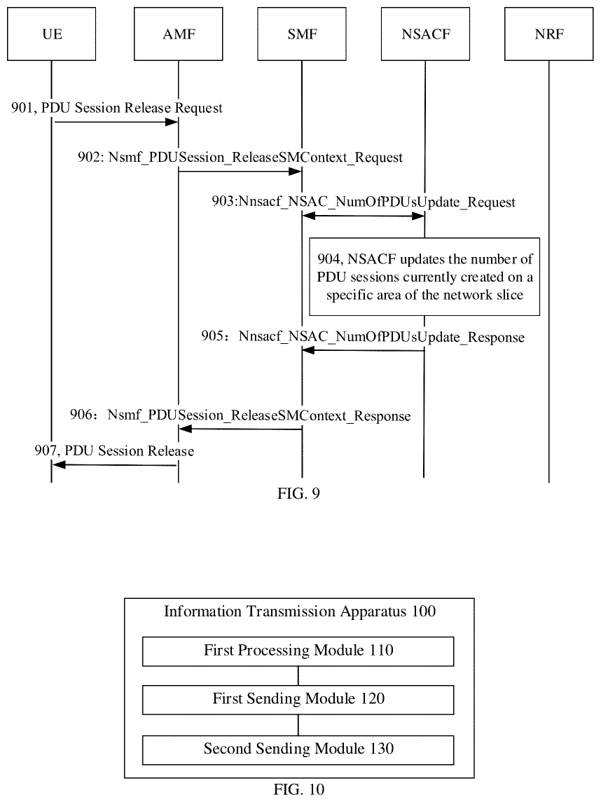

As shown in FIG. 9, in the process of releasing a session from a network slice, the specific steps of performing the validity check and update process of the number of sessions created within a slice specific area include:

step 901 to step 902, the UE requests to release a PDU session, initiates a process of releasing the session, and carries a session ID and corresponding slice identifier information to the network. The SMF determines that the slice needs to execute the NSAC process, and then triggers the validity check and update process of the number of sessions of the slice.

Specifically, in step 901, the UE sends a PDU session release request to the AMF.

Step 902, the AMF requests the SMF to release the PDU session through a command Nsmf_PDUSession_ReleaseSMContext_Request.

Step 903 to step 905, specific contents of execution respectively correspond to the specific contents of step 702 to step 704 shown in FIG. 7 in Example 1, which will not be repeated here. The update indication sent by the SMF is to reduce the number of sessions, and the NSACF performs corresponding updates.

Step 903 to step 905, the network side returns a PDU session release response message to the UE, and the process of releasing the session is completed.

An embodiment of the present disclosure also provides an information transmission apparatus, as shown in FIG. 10, which is applied in a network slice admission control function (NSACF) of cellular mobile wireless communication. The apparatus 100 includes:
a first processing module 110 configured to determine statistical information of one or more created sessions within a specific area range based on one or more network slices according to specific area indication information.

In one embodiment, the statistical information includes a number of sessions created within the specific area range.

In one embodiment, the specific area indication information includes at least one of:
a cell identifier (ID);
a tracking area ID (TAI);
an ID of an area of interest (AoI);
a TAI list;
an ID of a service area; or
an ID of a geography area.

In one embodiment, the specific area indication information is pre-stored in the NSACF; or,
the specific area indication information is sent to the NSACF by a consumer network function.

In one embodiment, the first processing module 110 is specifically configured to in response to receiving a statistical information update request of a session management function (SMF), determine the statistical information of the sessions created within the specific area range based on the network slices.

In one embodiment, the statistical information update request includes:
one or more statistical information update requests corresponding one or more session operations.

In one embodiment, the session operations include one of:
one or more operations of creating the sessions based on the network slices; or
one or more operations of releasing the sessions from the network slices.

In one embodiment, the statistical information update request carries service area information of the SMF and/or location information of the UE corresponding to the session operation, and
the first processing module 110 is specifically configured to determine whether to count the sessions corresponding to the session operations in the statistical information based on the service area information of the SMF and/or the location information.

In one embodiment, the service area information of the SMF includes user plane function (UPF) service area information corresponding to the SMF.

In one embodiment, the location information includes at least one of:
cell information; or
tracking area information.

In one embodiment, the statistical information update request carries one or more slice identifiers (IDs), and
determining statistical information of the sessions created within the specific area range based on the network slices includes:
determining the statistical information of the sessions created within the specific area range based on the network slices indicated by the slice IDs.

In one embodiment, the apparatus further includes:
a first sending module 120 configured to send the statistical information to a session management function (SMF).

In one embodiment, the specific area range of the network slices has a maximum number of sessions allowed to create sessions.

In one embodiment, the apparatus further includes:
a second sending module 130 configured to in response to a number of sessions created within the specific area range of the network slices reaching the maximum number of sessions, send reaching maximum number indication information indicating that the number of sessions created within the specific area range of the network slices reaches the maximum number of sessions to a session management function (SMF).

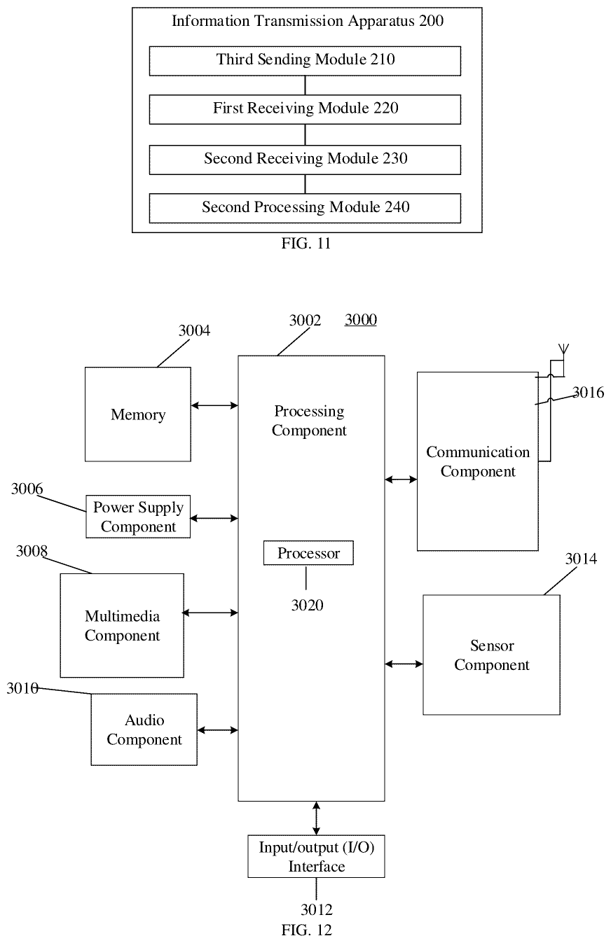

An embodiment of the present disclosure also provides an information transmission apparatus, as shown in FIG. 11, which is applied in a session management function (SMF) of cellular mobile wireless communication. The apparatus 200 includes:
a third sending module 210 configured to send a statistical information update request, wherein the statistical information update request is configured to indicate a network slice admission control function (NSACF) to determine statistical information of one or more sessions created within a specific area range based on one or more network slices according to specific area indication information.

In one embodiment, the statistical information includes a number of sessions created within the specific area range.

In one embodiment, the specific area indication information includes at least one of:
a cell identifier (ID);
a tracking area ID (TAI);
an ID of an area of interest (AoI);
a TAI list;
an ID of a service area; or
an ID of a geography area.

In one embodiment, the statistical information update request includes:
one or more statistical information update requests corresponding one or more session operations.

In one embodiment, the session operations include one of:
one or more operations of creating the sessions based on the network slices; or
one or more operations of releasing the sessions from the network slices.

In one embodiment, the statistical information update request carries service area information of the SMF and/or location information of the UE corresponding to the session operation,
the location information is configured for the NSACF to determine whether to count the sessions corresponding to the session operations in the statistical information.

In one embodiment, the location information includes at least one of:
cell information; or
tracking area information.

In one embodiment, the location information is received from an access and mobility management function (AMF); and/or,
the location information is obtained from a gateway mobile location center (GMLC).

In one embodiment, the service area information of the SMF includes user plane function (UPF) service area information corresponding to the SMF.

In one embodiment, the statistical information update request carries one or more slice identifiers (IDs); and
the statistical information update request is configured to indicate the NSACF to determine the statistical information of the sessions created within the specific area range based on the network slices indicated by the slice IDs.

In one embodiment, the apparatus 200 further includes:
a first receiving module 220 configured to receive the statistical information sent by the NSACF.

In one embodiment, the specific area range of the network slices has a maximum number of sessions allowed to create sessions, and
the apparatus 200 further includes:
a second receiving module 230 configured to receive reaching maximum number indication information, wherein the reaching maximum number indication information is configured to indicate that the number of sessions created within the specific area range reaches the maximum number of sessions.

In one embodiment, the apparatus 200 further includes:
a second processing module 240 configured to in response to receiving the reaching maximum number indication information, stop creating the sessions in the network slices indicated by one or more slice identifiers (IDs).

In an exemplary embodiment, the first processing module 110, the first sending module 120, the second sending module 130, the third sending module 210, the first receiving module 220, the second receiving module 230 and the second processing module 240 may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field-programmable gate arrays (FPGAs), general processors, controllers, micro controller units (MCUs), microprocessors or other electronic components for performing the above methods.

FIG. 12 is a block diagram illustrating a device 3000 for information transmission according to an exemplary embodiment. For example, the device 3000 may be a mobile phone, a computer, a digital broadcast terminal, a messaging device, a game console, a tablet device, a medical device, a fitness device, a personal digital assistant, and the like.

Referring to FIG. 12, the device 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the overall operations of the device 3000, such as the operations associated with display, telephone calls, data communications, camera operations, and recording operations. The processing component 3002 may include one or more processors 3020 to execute instructions to complete all or part of the steps of the above-mentioned method. Additionally, the processing component 3002 may include one or more modules which facilitate the interaction between the processing component 3002 and other components. For example, the processing component 3002 may include a multimedia module to facilitate the interaction between the multimedia component 3008 and the processing component 3002.

The memory 3004 is configured to store various types of data to support the operation of the device 3000. Examples of such data include instructions for any application or methods operated on the device 3000, contact data, phonebook data, messages, pictures, videos, and the like. The memory 3004 may be implemented using any type of volatile or non-volatile storage device, or a combination thereof, such as a static random access memory (SRAM), an electrically erasable programmable read-only memory (EEPROM), an erasable programmable read only memory (EPROM), a programmable read only memory (PROM), a read-only memory (ROM), a magnetic memory, a flash memory, a magnetic or optical disk.

The power supply component 3006 provides power to various components of the device 3000. The power supply component 3006 may include a power management system, one or more power sources, and any other components associated with the generation, management, and distribution of power in the device 3000.

The multimedia component 3008 includes a screen providing an output interface between the device 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or a swipe action, but also sense awake time and a pressure associated with the touch or swipe action. In some embodiments, the multimedia component 3008 includes a front camera and/or a rear camera. The front camera and/or the rear camera may receive an external multimedia datum while the device 3000 is in an operation mode, such as a photographing mode or a video mode. Each of the front camera and the rear camera may be a fixed optical lens system or have focal and optical zoom capability.

The audio component 3010 is configured to output and/or input audio signals. For example, the audio component 3010 includes a microphone (MIC) configured to receive an external audio signal when the device 3000 is in an operation mode, such as a call mode, a recording mode and a voice recognition mode. The received audio signal may be further stored in the memory 3004 or transmitted via communication component 3016. In some embodiments, the audio component 3010 further includes a speaker to output audio signals.

The I/O interface 3012 provides an interface between the processing component 3002 and peripheral interface modules, such as keyboards, click wheels, buttons, and the like. These buttons may include, but are not limited to, a home button, a volume button, a starting button, and a locking button.

The sensor component 3014 includes one or more sensors to provide status assessments of various aspects of the device 3000. For example, the sensor component 3014 may detect an open/close status of the device 3000, relative positioning of components, e.g., the display and the keypad, of the device 3000, a change in position of the device 3000 or a component of the device 3000, a presence or absence of user contact with the device 3000, an orientation or an acceleration/deceleration of the device 3000, and a change in temperature of the device 3000. The sensor component 3014 may include a proximity sensor configured to detect the presence of nearby objects without any physical contact. The sensor component 3014 may also include a light sensor, such as a CMOS or CCD image sensor, for use in imaging applications. In some embodiments, the sensor component 3014 may also include an acceleration sensor, a gyroscope sensor, a magnetic sensor, a pressure sensor or a temperature sensor.

The communication component 3016 is configured to facilitate communication, wired or wireless, between the device 3000 and other devices. The device 3000 may access a wireless network based on a communication standard, such as Wi-Fi, 4G or 5G, or a combination thereof. In an exemplary embodiment, the communication component 3016 receives a broadcast signal or broadcast related information from an external broadcast management system via a broadcast channel. In an exemplary embodiment, the communication component 3016 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the device 3000 may be implemented with one or more application specific integrated circuits (ASICs), digital signal processors (DSPs), digital signal processing devices (DSPDs), programmable logic devices (PLDs), field programmable gate arrays (FPGA), controllers, microcontrollers, microprocessors, or other electronic components, for performing the above-described method.

In an exemplary embodiment, there is also provided a non-transitory computer-readable storage medium including instructions, such as included in the memory 3004, executed by the processor 3020 in the device 3000, for performing the above-mentioned method. For example, the non-transitory computer readable storage medium may be ROM, a random access memory (RAM), a CD-ROM, a magnetic tape, a floppy disk, an optical data storage device, and the like.

Other embodiments of the present disclosure will be apparent to those skilled in the art from consideration of the specification and practice of the present disclosure disclosed here. The present disclosure is intended to cover any variations, uses, or adaptations of embodiments of the present disclosure following the general principles thereof and including such departures from embodiments of the present disclosure as come within known or customary practice in the art. It is intended that the specification and the examples be considered as illustrative only, with a true scope and spirit of the embodiments of the present disclosure being indicated by the following claims.

It is appreciated that embodiments of the present disclosure are not limited to the exact construction that has been described above and illustrated in the accompanying drawings, and that various modifications and changes may be made without departing from the scope thereof. It is intended that the scope of embodiments of the present disclosure only be limited by the appended claims.

1. An information transmission method, performed by a network slice admission control function (NSACF), the method comprising:
determining statistical information of one or more sessions created within a specific area range based on one or more network slices according to specific area indication information.

2. The method according to claim 1, wherein the statistical information comprises a number of sessions created within the specific area range.

3. The method according to claim 1, further comprising at least one of:
the specific area indication information comprising at least one of:
a cell identifier (ID);
a tracking area ID (TAI);
an ID of an area of interest (AoI);
a TAI list;
an ID of a service area; or
an ID of a geography area; or
the specific area indication information being pre-stored in the NSACF, or sent to the NSACF by a consumer network function.

4. (canceled)

5. The method according to claim 1, wherein determining statistical information of the sessions created within the specific area range based on the network slices comprises:
receiving a statistical information update request of a session management function (SMF), and determining the statistical information of the sessions created within the specific area range based on the network slices,
wherein the statistical information update request comprises: one or more statistical information update requests corresponding one or more session operations.

6. (canceled)

7. The method according to claim 5, further comprising at least one of:
the session operations comprise one of:
one or more operations of creating the sessions based on the network slices; or
one or more operations of releasing the sessions from the network slices; or
the statistical information update request carries one or more slice identifiers (IDs), and determining statistical information of the sessions created within the specific area range based on the network slices comprises:
determining the statistical information of the sessions created within the specific area range based on the network slices indicated b the slice IDs.

8. The method according to claim 5, wherein the statistical information update request carries at least one of service area information of the SMF or location information of the UE corresponding to the session operation, and
determining statistical information of the sessions created within the specific area range based on the network slices comprises:
determining whether to count the sessions corresponding to the session operations in the statistical information based on the at least one of the service area information of the SMF or the location information;
wherein the method comprises at least one of:
the service area information of the SMF comprising user plane function (UPF) service area information corresponding to the SMF; or
the location information comprising at least one of cell information or tracking area information.

9.-11. (canceled)

12. The method according to claim 1, further comprising:
sending the statistical information to a session management function (SMF).

13. The method according to claim 1, wherein the specific area range of the network slices has a maximum number of sessions allowed to create sessions,
wherein the method further comprises:
sending reaching maximum number indication information indicating that a number of sessions created within the specific area range of the network slices reaches the maximum number of sessions to a session management function SMF wherein the number of sessions created within the specific area range of the network slices reaches the maximum number of sessions.

14. (canceled)

15. An information transmission method, performed by a session management function (SMF), the method comprising:
sending a statistical information update request, wherein the statistical information update request is configured to indicate a network slice admission control function (NSACF) to determine statistical information of one or more sessions created within a specific area range based on one or more network slices according to specific area indication information.

16. The method according to claim 15, wherein the statistical information comprises a number of sessions created within the specific area range.

17. (canceled)

18. The method according to claim 15, wherein the statistical information update request comprises:
one or more statistical information update requests corresponding one or more session operations.

19. The method according to claim 18, wherein the session operations comprise one of:
one or more operations of creating the sessions based on the network slices; or
one or more operations of releasing the sessions from the network slices.

20. The method according to claim 18, wherein the statistical information update request carries at least one of service area information of the SMF or location information of the UE corresponding to the session operation,
the location information is configured for the NSACF to determine whether to count the sessions corresponding to the session operations in the statistical information;
wherein the method comprises at least one of:
the location information comprising at least one of cell information or tracking area information;
the location information being received from an access and mobility management function (AMF) or obtained from a gateway mobile location center (GMLC); or
the service area information of the SMF comprising user plane function (UPF) service area information corresponding to the SMF.

21.-23. (canceled)

24. The method according to claim 15, wherein
the statistical information update request carries one or more slice identifiers (IDs); and
the statistical information update request is configured to indicate the NSACF to determine the statistical information of the sessions created within the specific area range based on the network slices indicated by the slice IDs.

25. The method according to claim 15, further comprising:
receiving the statistical information sent by the NSACF.

26. The method according to claim 15, wherein the specific area range of the network slices has a maximum number of sessions allowed to create sessions, and
the method further comprises:
receiving reaching maximum number indication information, wherein the reaching maximum number indication information is configured to indicate that the number of sessions created within the specific area range reaches the maximum number of sessions; or
receiving the reaching maximum number indication information, and stopping creating the sessions in the network slices indicated by one or more slice identifiers (IDs).

27.-29. (canceled)

30. A communication device, comprising:
a processor; and
a memory storing a program executable by the processor, wherein the processor performs:
determining statistical information of one or more sessions created within a specific area ran e based on one or more network slices according to specific area indication information.

31. A non-transitory storage medium having an executable program stored thereon, wherein when the executable program is executed by a processor, the processor is caused perform the method according to claim 1.

32. A communication device, comprising:
a processor; and
a memory storing a program executable by the processor,
wherein the processor performs the method according to claim 15.

33. A non-transitory storage medium having an executable program stored thereon, wherein when the executable program is executed by a processor, the processor is caused perform the method according to claim 15.
